(19) United States
(12) Patent Application Publication
(10) Pub. No.: US 2004/0105568 A1
(43) Pub. Date: Jun. 3, 2004

(54) Speaker with enhanced magnetic flux

(76) Inventor: Po-Hsiung Lee, Taipei (TW)

Correspondence Address: Jackson Walker L.L.P., Suite 2100, 112 E. Pecan Street, San Antonio, TX, 78205, US

(21) Appl. No.: 10/308,468

(22) Filed: Dec. 3, 2002

(51) Int. Cl. H04R 1/00; H04R 9/06; H04R 11/02

(52) U.S. Cl. 381/412; 381/414; 381/420; 381/421

(57) ABSTRACT

A speaker with enhanced magnetic flux loop includes a core magnet (12) installed inside hollow space of a bottom yoke (11), and a ring-shape magnet (13) with opposing polarity placed on the outer periphery of the core magnet (12). The ring-shape magnet (13) acts as an induction medium in a magnetic flux loop flowing across the core magnet (12), thus bottom yoke the magnetic flux within the boundary of the yoke (11) and preventing loss of magnetic flux. The dual magnet architecture brings about increased sensitivity to sound and output volume for the speaker, whilst the external dimensions of the conventional speaker can be scaled down as a result of smaller yoke (11).

### BACKGROUND OF THE INVENTION

1. Field of the Invention

The present invention relates to a speaker with enhanced magnetic flux, in particular to a speaker that uses dual magnets to enhance magnetic flux to boost the output volume of the speaker.

2. Description of Related Arts

FIG. 4 shows an exploded diagram of a conventional speaker, in which the basic elements include a permanent magnet (51), a central pole (52), a bottom yoke (50), a voice coil (53), a top yoke (54), a vibration damper (55), and a diaphragm (56), wherein the magnet (51) is placed in the center of a hollow bottom yoke (50); the central pole (52) is formed above the permanent magnet (51); the voice coil (53) is fed on the outer periphery of the central pole (52); the top yoke (54) is placed over the center opening of the bottom yoke (50); the top yoke (54) has a through holeat the center, allowing the assembly of the voice coil (53) and the central pole (52) to pass through the hole (541); the vibration damper (55) is installed over the voice coil (53); and the cone-shaped diaphragm (56) is installed over the damper (55). The diaphragm (56) is supported by the upper edge of the top yoke (54) and fixed by a circular frame (57); and a cover plate (561) is placed over the diaphragm (56) covering the voice coil (53) and the central pole (52) in the hollow space of the bottom yoke (50).

The operating principles of the speaker are to be described below. When the voice coil (53) is energized, a magnetic field is created by electromagnetic inductance with the magnet (51), which causes the vibration damper (55) to vibrate. The intensity of the current applied by the voice coil and the magnetic flux of the magnet (51) can determine the output volume of the speaker and the frequency response. The dotted line in the diagram represents the flow of magnetic flux from the magnet (51), wherein the bottom yoke (50) serves as an induction medium in a magnetic flux loop, flowing from the N pole of the magnet (51), cutting across the bottom yoke (50) and returning to the pole of the magnet (51). This magnetic field is the result of magnetic induction from the magnetic field of the voice coil.

FIG. 5 shows a partial view of cross-sectional diagram of another model of the conventional speaker. By comparison with the previous speaker, it can found that the main difference between the two models lies in the T-shaped yoke (50), which is coupled with a ring-shape permanent magnet (51) on the outer periphery to form a speaker employing an external magnet. The magnet (51) makes use of the T-shape yoke (50) as an induction medium to form a closed magnetic loop. As shown by the dotted line in the diagram, the magnetic flux of the ring-shape magnet (51) flows from the N pole cutting across the yoke (50) and returns to the S pole.

Both speaker models, whether employing an internal or external magnet, make use of the yoke (50) as the induction medium to form a closed magnetic loop. However, the yoke (50) will wear away the magnetic flux of the magnet over the long term, and cause the sensitivity to sound and output volume of the speaker to be degraded over time.

### SUMMARY OF THE INVENTION

The main object of the present invention is to provide a speaker with enhanced magnetic flux, by strengthening the magnetic flux within the boundary of the yoke, so as to improve the output volume and the sensitivity to sound of the speaker.

The speaker in accordance with the present invention is to install a core magnet in the center of the hollow yoke, and a ring-shape magnet with opposite polarity on the outer periphery of the core magnet, forming a ring-coupled dual magnet architecture. The ring-shape magnet acts as an induction medium in the magnetic flux loop, preventing loss of magnetic flux beyond the boundary of the yoke, and boosting the magnetic flux at the same time, thereby the sensitivity to sound and the output volume of the speaker can be considerably improved.

The secondary object of the invention is to provide a speaker that enables the conventional external dimensions of the speaker to be scaled down, whilst not affecting the output volume of the speaker. The miniaturized components for the speaker can also be used on other electronic devices.

The features and structure of the present invention will be more clearly understood when taken in conjunction with the accompanying drawings.

### BRIEF DESCRIPTION OF THE DRAWINGS

FIG. 1 is a cross sectional view of the present invention;

FIG. 2 is a performance curve of the frequency response versus the output volume of the speaker;

FIG. 3 is the performance curve of a conventional speaker;

FIG. 4 is a cross-sectional view of a conventional speaker; and

FIG. 5 is a cross-sectional view of another model of conventional speaker.

### DETAILED DESCRIPTION OF THE PREFERRED EMBODIMENT

The present invention, as practiced by the preferred embodiment, will hereinafter be described in reference to the drawings.

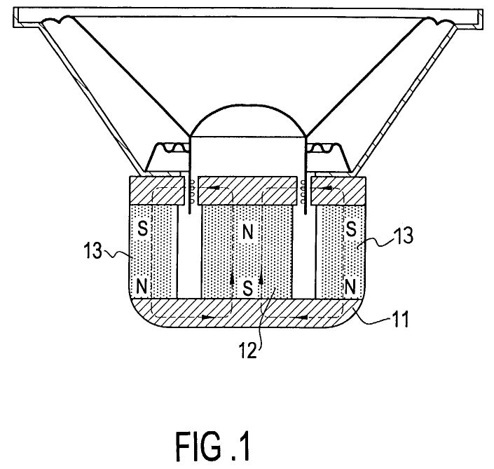

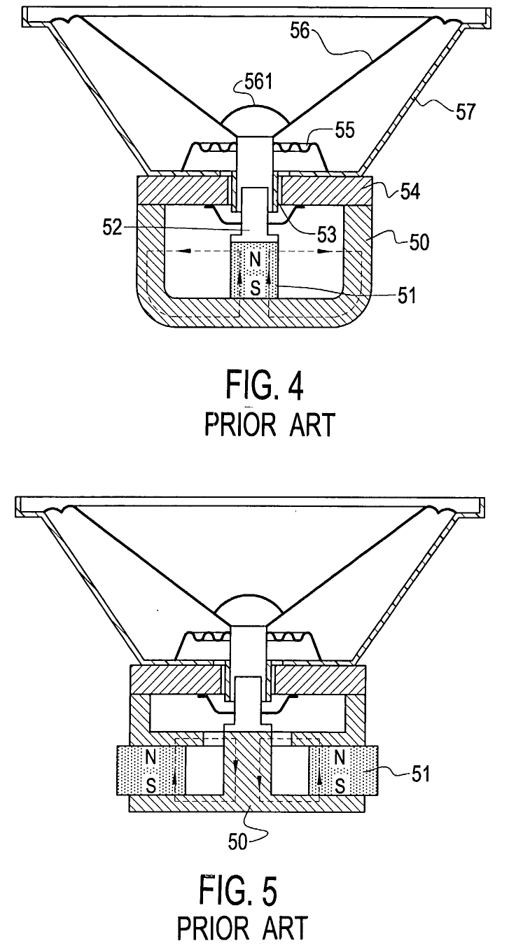

FIG. 1 shows a speaker built with enhanced magnetic flux in accordance with the present invention, where the components located over the opening of the hollow bottom yoke (11) are in general similar to those in FIGS. 4 and 5, including central pole (52), a top yoke (54), a voice coil (53), a vibration damper (55), and a diaphragm (56), so their structure will not be reiterated here. The unique feature of the present invention lies in the internal structure of the bottom yoke (11), in which two magnets, a core magnet (12) and a ring-shape magnet (13), are arranged in ring coupling so as to enhance the magnetic flux of the speaker.

Inside the hollow space of the bottom yoke (11), the ring-shape magnet (13) is fed onto the outer periphery of the core magnet (12), leaving a gap of predetermined width between the two magnets (12, 13). These two magnets are coupled in a way that the polarity of the ring-shape magnet (13) directly opposes the core magnet (12). As shown in the diagram, the dotted line shows the magnetic flux flows from the N pole of the core magnet (12), cuts across the ring-shape magnet (13) from south to north, and then returns to the S pole of the core magnet (12), thus forming a magnetic flux loop. Since the ring-shape magnet (13) serves as the induction medium for the magnetic flux loop, the function of the bottom yoke (11) becomes significantly lessened, and the chance of losing magnetic flux is considerably reduced. Under such magnet arrangement, the core magnet is able to generate strong magnetic flux for the speaker system.

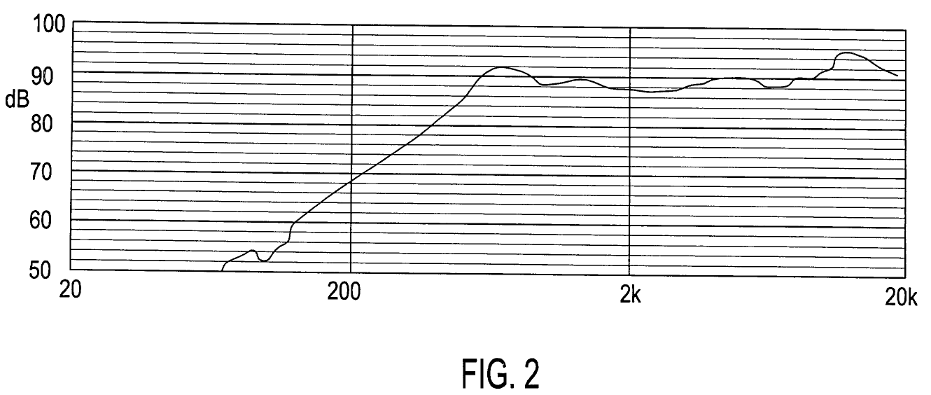

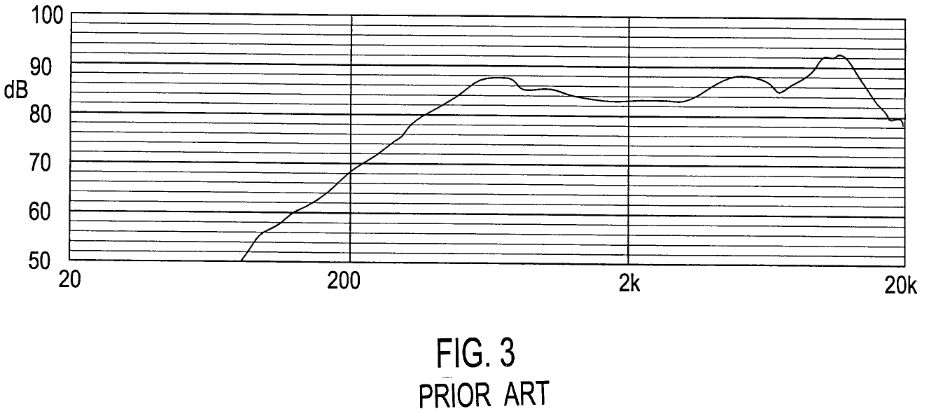

FIGS. 2 and 3 give a comparison of the performance curves between the new speaker in the present invention and the conventional speaker, where the x-axis represents frequency response using uniform interval, whilst the Y-axis represents the output volume. The diagram reveals that the output volume of the speaker in the present invention outperforms the conventional speaker in the range of frequency responses.

| | Frequency response | | | |
|---|---|---|---|---|
| | 1.0 Khz | 1.2 Khz | 1.5 Khz | 2.0 Khz |
| Output volume in dB | | | | |
| Present invention | 89.08 dB | 89.01 dB | 89.39 dB | 88.09 dB |
| Conventional speaker | 84.63 dB | 84.06 dB | 83.15 dB | 82.61 dB |

In the table above, it is apparent that the coupling of the core magnet (12) and the ring-shape magnet (13) can effectively boost the magnetic flux, causing the output volume to be increased across all frequency responses.

From the foregoing, not only the output volume of the speaker having the dual magnet architecture can be improved, the size of the speaker and the internal components, such as the yoke, can also be reduced. These internal components can also be used on other electronic products such as mobile phones and miniature FM/AM radios.

The foregoing description of the preferred embodiments of the present invention is intended to be illustrative only and, under no circumstances, should the scope of the present invention be so restricted.

What is claimed is:

1. A speaker with enhanced magnetic flux includes a bottom yoke (11) with a hollow center wherein:
a vibration damper (55), a voice coil (53), and a top yoke (54) are provided over a central opening of the bottom yoke (11);
a core magnet (12) is provided in the hollow space of the bottom yoke (11); and
a ring-shape magnet (13) is also provided inside the bottom yoke (11) and on the outer periphery of the core magnet (12), sharing the same coaxial and leaving a gap of predetermined width between the two magnets (12, 13).

2. The speaker with enhanced magnetic flux as claimed in claim 1, wherein the core magnet (12) and the ring-shape magnet (13) are arranged with polarity directly opposing each other to form a closed magnetic flux loop.
